(19) United States
(12) Patent Application Publication
(10) Pub. No.: US 2026/0147308 A1
(43) Pub. Date: May 28, 2026

(54) IMAGE FORMING APPARATUS

(71) Applicant: KYOCERA Document Solutions Inc., Osaka (JP)

(72) Inventors: Koji TANIO, Osaka (JP); Teruhiko NAGASHIMA, Osaka (JP)

(73) Assignee: KYOCERA Document Solutions Inc., Osaka (JP)

(21) Appl. No.: 19/391,708

(22) Filed: Nov. 17, 2025

(30) Foreign Application Priority Data
Nov. 22, 2024 (JP) 2024-203608

(51) Int. Cl. G03G 21/16

(52) U.S. Cl. CPC G03G 21/1633; G03G 21/1647; G03G 21/1652; G03G 2221/163; G03G 2221/166

(57) ABSTRACT

An image forming apparatus includes a main body, a container, an outer cover and an inner cover which is supported turnably around a second axis with respect to the outer cover. The inner cover sandwiches the container between the outer cover and an upper part located above the second axis. After the inner cover enters the main body, by pressing the inner cover toward an outer side, the upper part of the inner cover is turned around the second axis to approach the container. The inner cover includes an engagement portion in a lower part located below the second axis. In a state where the inner cover is not pressed toward the outer side, the container engages with the engagement portion.

### INCORPORATION BY REFERENCE

This application is based upon and claims the benefit of priority from the corresponding Japanese Patent Application No. 2024-203608 (filed on November 22, 2024), the entire contents of which are incorporated herein by reference.

### BACKGROUND

The present disclosure relates to an image forming apparatus including a container which stores a toner.

A conventional image forming apparatus uses a toner to perform printing. The toner is stored in a container.

A container is removable from the main body of an image forming apparatus. When the container is empty, the empty container is removed, and a new container is fitted. In this configuration, when the container is fitted into the main body of the image forming apparatus, the container may be shifted. When the container is shifted, for example, a problem occurs in which a cover for covering the container from the outside cannot be closed.

### SUMMARY

An image forming apparatus according to an aspect of the present disclosure includes a main body, a container, an outer cover and an inner cover. The main body includes a printing unit. The container stores a toner used in printing performed in the printing unit. The outer cover is supported turnably around a first axis orthogonal to an up/down direction, includes a fitting region into which the container is removably fitted and is displaceable between an open position where the outer cover is turned around the first axis to expose the fitting region to an outside of the main body, and the container is removable from the fitting region and a closed position where the container in the fitting region is placed inside the main body. The inner cover is supported turnably around a second axis parallel to the first axis with respect to the outer cover, and sandwiches the container in the fitting region between the outer cover and the inner cover. The inner cover sandwiches, inside the main body, the container in the fitting region, between the outer cover and an upper part located above the second axis. After the outer cover is turned from the open position toward the closed position such that the upper part of the inner cover enters the main body, by pressing the upper part of the inner cover from an inner side of the main body toward an outer side thereof, the upper part of the inner cover is turned around the second axis to be displaced in a direction in which the upper part approaches the container in the fitting region (3A). The inner cover includes an engagement portion in a lower part located below the second axis. In a state where the upper part of the inner cover is not pressed from the inner side of the main body toward the outer side thereof, the container in the fitting region engages with the engagement portion.

### BRIEF DESCRIPTION OF THE DRAWINGS

FIG. 1 is a perspective view of an image forming apparatus according to an embodiment;

FIG. 2 is a perspective view in a state where one of outer covers in the image forming apparatus shown in FIG. 1 is in an open position;

FIG. 3 is a schematic view showing the internal configuration of the image forming apparatus according to the embodiment;

FIG. 4 is a schematic view of an image formation unit in the image forming apparatus shown in FIG. 3 and an area around the image formation unit;

FIG. 5 is a perspective view of a container which is fitted into the main body of the image forming apparatus according to the embodiment;

FIG. 6 is a perspective view of the container which is fitted into the main body of the image forming apparatus according to the embodiment;

FIG. 7 is a perspective view of the container which has been fitted into the outer cover in the image forming apparatus according to the embodiment and an area around the container;

FIG. 8 is a schematic view showing a positional relationship between the container and an inner cover in a state where the outer cover in the image forming apparatus according to the embodiment is in the open position;

FIG. 9 is a schematic view showing a positional relationship between the container and the inner cover in a state where the outer cover in the image forming apparatus according to the embodiment is in a closed position;

FIG. 10 is an enlarged plan view of an engagement protrusion of the inner cover in the image forming apparatus according to the embodiment and an area around the engagement protrusion; and

FIG. 11 is an enlarged perspective view of an engagement recess in the container which is fitted into the image forming apparatus according to the embodiment.

### DETAILED DESCRIPTION

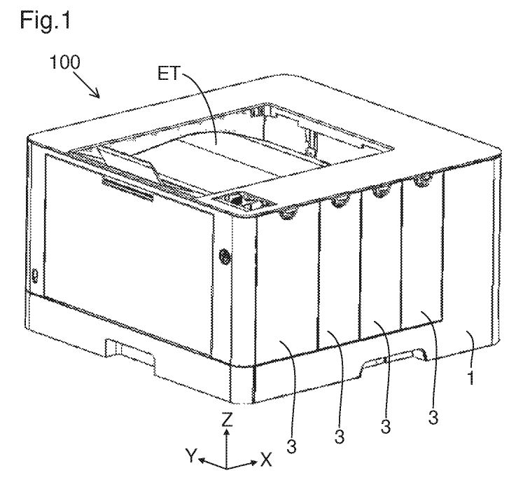

An image forming apparatus 100 in the present embodiment will be described below with reference to FIGS. 1 to 11. The image forming apparatus 100 is installed on a substantially horizontal, flat floor surface FL. A vertical direction perpendicular to the floor surface FL is an up/down direction in the image forming apparatus 100. One of horizontal directions is a forward/backward direction in the image forming apparatus 100, and the other direction orthogonal to the one direction is a left/right direction in the image forming apparatus 100.

In the drawings referenced in the following description, for ease of understanding, an XYZ Cartesian coordinate system is shown. A Z direction is the vertical direction which is the up/down direction in the image forming apparatus 100. The floor surface FL is a surface which is perpendicular to the Z direction. A direction indicated by the arrow of the Z direction is an upward direction, and a direction opposite thereto is a downward direction.

An X direction is one of the horizontal directions, and a Y direction is the other of the horizontal directions. For example, the X direction corresponds to the forward/backward direction in the image forming apparatus 100. The Y direction corresponds to the left/right direction in the image forming apparatus 100.

### Configuration of image forming apparatus

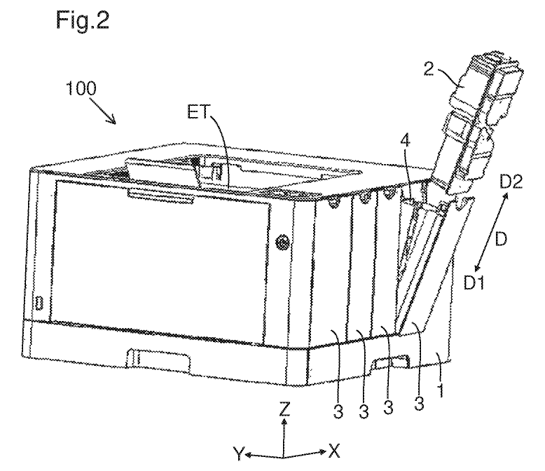

As shown in FIGS. 1 and 2, the image forming apparatus 100 includes a main body 1. The image forming apparatus 100 also includes containers 2. The containers 2 store toners used in printing. The containers 2 are fitted into the main body 1. The number of containers 2 fitted is four. The containers 2 correspond to cyan, magenta, yellow and black. In the containers 2, the toners corresponding to the colors are stored.

The containers 2 are removable from the main body 1. A user manually performs a fitting/removal operation on each of the containers 2. For example, when any one of the containers 2 is empty, the empty container 2 is removed, and a new container 2 is fitted.

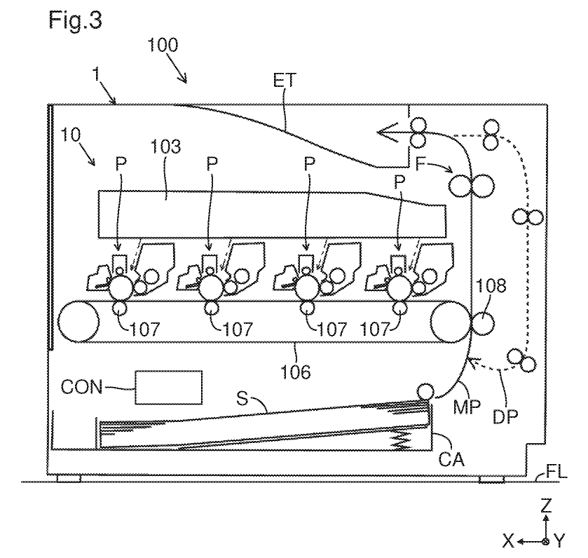

As shown in FIG. 3, the main body 1 includes a printing unit 10. The printing unit 10 prints an image on a sheet S. The sheets S used in printing are stored in a sheet cassette CA. The sheet cassette CA is removably fitted into the main body 1.

The printing unit 10 includes a main conveyance path MP. The main conveyance path MP extends through a transfer position and a fixing position in this order, and reaches an ejection tray ET.

In the printing performed by printing unit 10, the sheet S in the sheet cassette CA is supplied to the main conveyance path MP, and the sheet S is conveyed along the main conveyance path MP. An image is formed using the toners. Then, the image is printed on the sheet S being conveyed. In other words, transfer processing (specifically, secondary transfer) for the image on the sheet S being conveyed is performed in the transfer position. In the fixing position, fixing processing for the image on the sheet S is performed.

The printing unit 10 includes four image formation units P corresponding to the colors of cyan, magenta, yellow and black. Each of the image formation units P uses the toner of the corresponding color to form an image.

Although attention is focused on one of the image formation units P, and its configuration will be described below, the configurations of the image formation units P are the same as each other. Hence, the following description can be used for the description of the configurations of the other image formation units P, and thus the description is omitted.

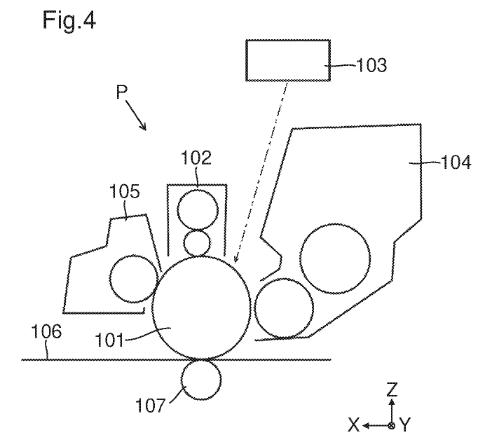

The image formation unit P has the configuration as shown in FIG. 4. The image formation unit P includes a photosensitive drum 101, a charging device 102, an exposure device 103, a development device 104 and a cleaning device 105.

The photosensitive drum 101 is supported rotatably around an axis extending in the left/right direction (Y direction). The photosensitive drum 101 is rotated while carrying a toner image on its outer circumferential surface. The charging device 102 charges the outer circumferential surface of the photosensitive drum 101. The exposure device 103 exposes the outer circumferential surface of the photosensitive drum 101 to form an electrostatic latent image on the outer circumferential surface of the photosensitive drum 101. The development device 104 receives the supply of the toner from the container 2 which stores the toner of the corresponding color. The development device 104 uses the toner to develop the electrostatic latent image on the outer circumferential surface of the photosensitive drum 101 into the toner image. The cleaning device 105 removes the toner left on the outer circumferential surface of the photosensitive drum 101.

As shown in FIG. 3, the printing unit 10 includes an intermediate transfer belt 106. The intermediate transfer belt 106 is a seamless belt. The intermediate transfer belt 106 is stretched on a plurality of tension rollers (the symbols of which are omitted).

The intermediate transfer belt 106 is disposed such that its outer circumferential surface is in contact with the outer circumferential surface of each of the photosensitive drums 101. On the outer circumferential surface of the intermediate transfer belt 106, the toner images on the outer circumferential surfaces of the photosensitive drums 101 are primarily transferred. The intermediate transfer belt 106 is rotated while carrying the toner images on its outer circumferential surface. In this way, the toner images on the outer circumferential surface of the intermediate transfer belt 106 are conveyed toward the transfer position.

The printing unit 10 includes primary transfer rollers 107. The four primary transfer rollers 107 are provided. The primary transfer rollers 107 are allocated to the photosensitive drums 101, respectively.

The printing unit 10 includes a secondary transfer roller 108. The secondary transfer roller 108 is pressed against the outer circumferential surface of the intermediate transfer belt 106 in the transfer position, and forms a transfer nip between the intermediate transfer belt 106 and the secondary transfer roller 108. The main conveyance path MP extends via the transfer nip.

In a print job, the sheet S is conveyed toward the transfer position (that is, the transfer nip). Each of the image formation units P uses the toner of the corresponding color to form the toner image. The primary transfer rollers 107 primarily transfer the toner images to the outer circumferential surface of the intermediate transfer belt 106. The intermediate transfer belt 106 is rotated while carrying the toner images. The secondary transfer roller 108 secondarily transfers the toner images to the sheet S which is being passed through the transfer position.

The image forming apparatus 100 includes a fixing unit F. The fixing unit F includes a heating roller and a pressure roller. The heating roller incorporates a heater. The pressure roller is pressed against the heating roller. The heating roller and the pressure roller are pressed against each other to form a fixing nip in the fixing position.

In the print job, the sheet S is passed through the fixing position (that is, the fixing nip). The fixing unit F heats the sheet S being passed through the fixing position, and pressurizes the sheet S. The fixing unit F heats and pressurizes the sheet S to fix the toner images on the sheet S. The sheet S on which the fixing processing has been performed is ejected to the ejection tray ET.

The image forming apparatus 100 includes a double-sided printing conveyance path DP. In this way, the image forming apparatus 100 can perform not only a single-sided print job for printing an image on only one side of the sheet S but also a double-sided print job for printing images on both sides of the sheet S.

The double-sided printing conveyance path DP branches from the main conveyance path MP in a branch position on a downstream side of the main conveyance path MP in a sheet conveyance direction with respect to the fixing position. The double-sided printing conveyance path DP merges into the main conveyance path MP in a merging position on an upstream side of the main conveyance path MP in the sheet conveyance direction with respect to the transfer position.

When a job to be performed is the single-sided print job, the sheet S is passed through the transfer position only once, and the transfer processing is performed on the sheet S being passed through the transfer position. Then, after the first transfer processing, the sheet S is ejected to the ejection tray ET without being processed.

When a job to be performed is the double-sided print job, the transfer processing is performed once on each of the front and back sides of the sheet S, and thus the sheet S is passed through the transfer position twice. Specifically, when the sheet S is passed through the transfer position for the first time, the transfer processing is performed on one side of the sheet S. After the first transfer processing, the sheet S is switched back after the back end of the sheet S is passed through the branch position and before the sheet S is completely ejected to the ejection tray ET. In this way, the sheet S is drawn from the back end into the double-sided printing conveyance path DP.

Thereafter, the sheet S is conveyed along the double-sided printing conveyance path DP, and the sheet S is returned from the merging position to the main conveyance path MP. In this way, the sheet S is passed through the transfer position again. Here, the orientation of the front and back sides of the sheet S is reversed from the orientation when the sheet S was passed through the transfer position the previous time. Consequently, when the sheet S is passed through the transfer position for the second time, the transfer processing is performed on the other side of the sheet S opposite to the one side of the sheet S.

### Mechanism for holding container

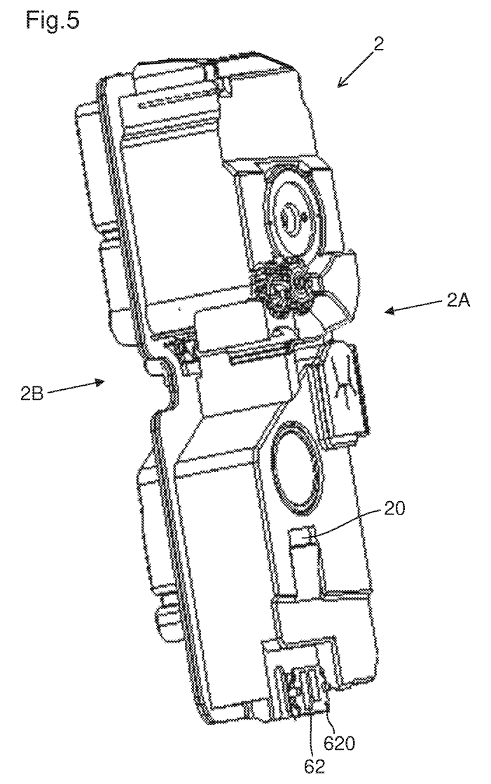

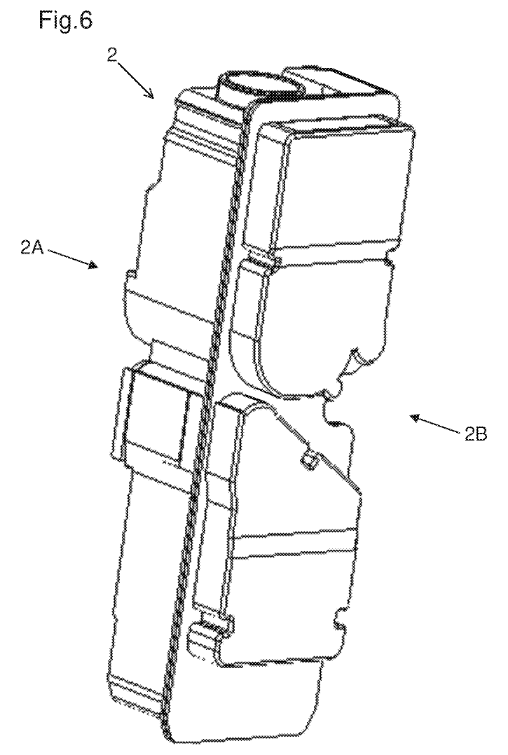

The container 2 has a configuration as shown in FIGS. 5 and 6. The side of the container 2 indicated by an arrow 2A is directed to the inside of the main body 1, and the side of the container 2 indicated by an arrow 2B is directed to the outside of the main body 1. The basic configurations of the containers 2 are the same as each other. The capacity of the container 2 for storing the toner of black may be larger than the capacities of the containers 2 for storing the toners of the other colors.

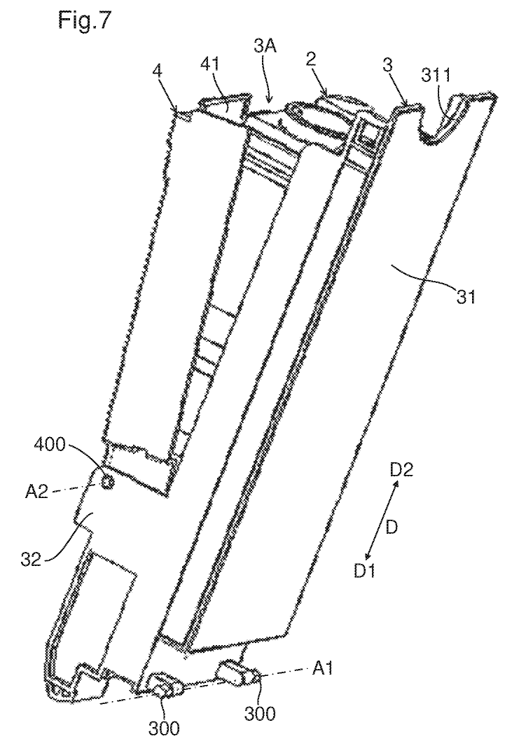

In order to hold the container 2, a mechanism as shown in FIG. 7 is used. The container 2 is held by an outer cover 3 and an inner cover 4. In other words, the image forming apparatus 100 includes the outer cover 3 and the inner cover 4.

The outer cover 3 is made of resin. The outer cover 3 may be made of sheet metal. The outer cover 3 is a part of an exterior which covers the interior of the main body 1 from an outer side. In other words, the outer cover 3 includes an exterior surface 31.

The outer cover 3 is attached to the main body 1 to be openable and closable. When the user performs the fitting/removal operation on the container 2, the outer cover 3 is manually opened and closed. For example, the outer cover 3 includes, as a handle 311, a part which is cut downward from the upper edge of the exterior surface 31. When the outer cover 3 is opened or closed, a finger of the user is placed on the handle 311.

The outer cover 3 is supported turnably around a first axis A1 with respect to the main body 1. The outer cover 3 is turned around the first axis A1 to be opened and closed. The first axis A1 is an axis extending in the forward/backward direction (X direction). In other words, the first axis A1 is an axis orthogonal to the up/down direction.

The outer cover 3 includes a pair of support pins 300. The pair of support pins 300 are disposed on the first axis A1, and extend in the axial direction of the first axis A1. On the other hand, the main body 1 includes a pair of support holes though the pair of support holes are not shown in the figure. The pair of support holes in the main body 1 are disposed on the first axis A1, and are opened in the axial direction of the first axis A1. The pair of support pins 300 are fitted into the pair of support holes in the main body 1. The pair of support pins 300 are slidable around the first axis A1 relative to the support holes into which the pair of support pins 300 are fitted. In this way, the outer cover 3 can be turned with the first axis A1 serving as a support point.

The outer cover 3 includes a fitting region 3A on the back surface side of the exterior surface 31 (that is, the inner side of the main body 1). The container 2 is fitted into the fitting region 3A. The container 2 is removable from the fitting region 3A. The outer cover 3 is displaced around the first axis A1, and thus it is possible to cause the outer cover 3 to reach positions in which the container 2 can be fitted and removed.

Specifically, the outer cover 3 is turned around the first axis A1 to be displaceable between an open position and a closed position. The outer cover 3 is brought into a state where the outer cover 3 is opened in the open position, and is brought into a state where the outer cover 3 is closed in the closed position.

In a state where the outer cover 3 is in the closed position, the fitting region 3A is placed inside the main body 1. In other words, the container 2 in the fitting region 3A is placed inside the main body 1. The container 2 placed inside the main body 1 is brought into a state where the container 2 is covered by the outer cover 3 from the outer side of the main body 1.

In the state where the outer cover 3 is in the closed position (that is, in the state where the container 2 is placed inside the main body 1), the container 2 is located inside the main body 1. The container 2 is connected to the development device 104 via a toner distribution path (not shown). In this way, it is possible to supply the toner from the container 2 to the development device 104.

In a state where the outer cover 3 is in the open position, the fitting region 3A is exposed to the outside of the main body 1. In other words, the container 2 in the fitting region 3A is exposed to the outside of the main body 1. In this way, the container 2 is removable from the fitting region 3A. When the outer cover 3 is in the open position, the container 2 is removable from the fitting region 3A.

A rotation angle between the open position and the closed position of the outer cover 3 about the first axis A1 is less than 90˚, and the outer cover 3 cannot be opened when the rotation angle is equal to or greater than 90˚. Hence, the direction of fitting/removal D of the container 2 relative to the fitting region 3A is inclined with respect to the up/down direction and the horizontal direction. In other words, when the container 2 is fitted into the fitting region 3A, the container 2 is moved diagonally downward (in the direction of fitting D1). When the container 2 is removed from the fitting region 3A, the container 2 is moved diagonally upward (in the direction of removal D2).

The inner cover 4 is made of resin. The inner cover 4 may be made of sheet metal. The inner cover 4 covers the container 2 in the fitting region 3A from the inner side of the main body 1. In a state where the container 2 is fitted into the fitting region 3A, the container 2 is covered by the outer cover 3 from the outer side of the main body 1, and is covered by the inner cover 4 from the inner side of the main body 1. In other words, the container 2 is disposed between the outer cover 3 and the inner cover 4. Furthermore, in other words, a region between the outer cover 3 and the inner cover 4 is the fitting region 3A.

The inner cover 4 is supported turnably around a second axis A2 with respect to the outer cover 3. The second axis A2 is an axis extending in the forward/backward direction (X direction). In other words, the second axis A2 is an axis parallel to the first axis A1.

The inner cover 4 includes a pair of support pins 400. The pair of support pins 400 are disposed on the second axis A2, and extend in the axial direction of the second axis A2. On the other hand, the outer cover 3 includes a pair of support holes (the symbols of which are omitted). The pair of support holes in the outer cover 3 are disposed on the second axis A2, and are opened in the axial direction of the second axis A2. In the outer cover 3, the support holes are respectively formed in a pair of side walls 32 opposite each other in the forward/backward direction. The pair of support pins 400 are fitted into the pair of support holes in the outer cover 3. The pair of support pins 400 are slidable around the second axis A2 relative to the support holes into which the pair of support pins 400 are fitted. In this way, the inner cover 4 can be turned with the second axis A2 serving as a support point.

The inner cover 4 sandwiches, inside the main body 1, the container 2 in the fitting region 3A, between the outer cover 3 and an upper part 41 located above the second axis A2. In the following description, the upper part 41 of the inner cover 4 is referred to as the inner cover upper part 41. The inner cover upper part 41 is displaced in conjunction with the turning of the outer cover 3 around the first axis A1. In other words, the inner cover upper part 41 is displaced according to the position of the outer cover 3.

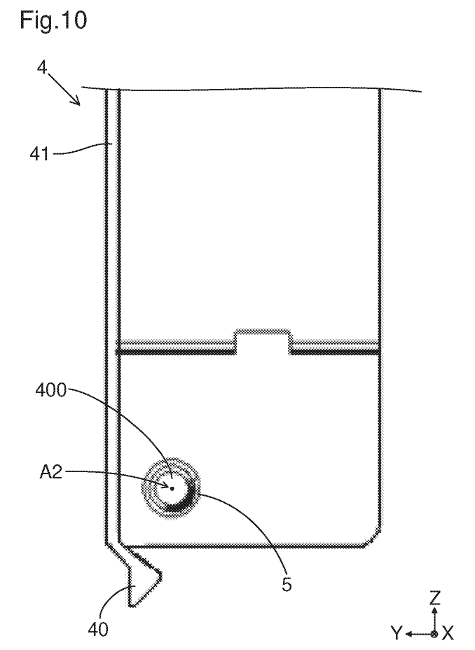

Specifically, the image forming apparatus 100 includes a torsion coil spring 5 (see FIG. 10). The torsion coil spring 5 corresponds to a “biasing member”. The torsion coil spring 5 is disposed in at least one of the pair of support pins 400. In other words, the torsion coil spring 5 is disposed on the second axis A2. Although not shown in the figure, one arm of the torsion coil spring 5 engages with the outer cover 3, and the other arm engages with the inner cover 4. The inner cover 4 is biased by the biasing force of the torsion coil spring 5 in a direction in which the inner cover upper part 41 is moved away from the outer cover 3.

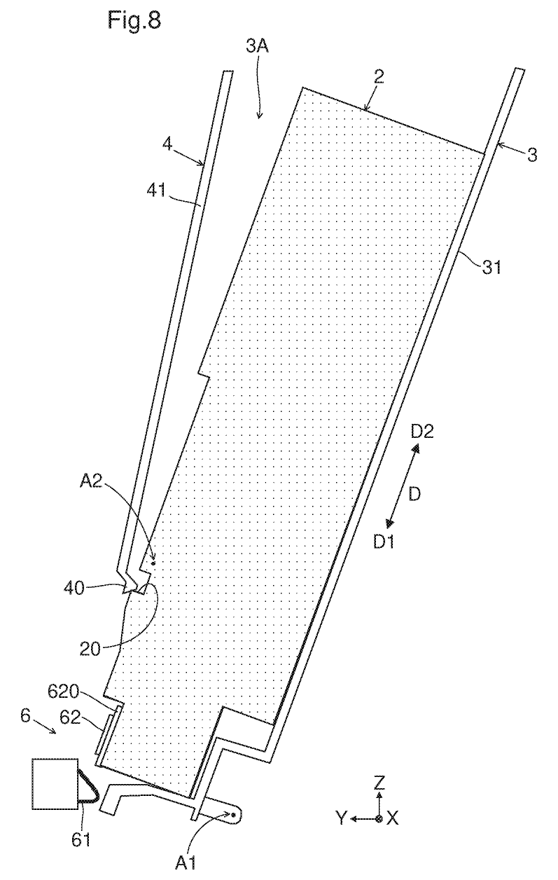

In the state where the outer cover 3 is in the open position, as shown in FIG. 8, the inner cover upper part 41 is moved away from the outer cover 3 to the maximum extent by the biasing force of the torsion coil spring 5. In other words, the fitting region 3A is opened. In this way, the container 2 is removable from the fitting region 3A.

When the container 2 is fitted into or removed from the fitting region 3A, the user moves the container 2 in the direction of fitting/removal D. Here, the inner cover upper part 41 functions as a guide. The inner cover upper part 41 guides the movement of the container 2 in the direction of fitting/removal D. When the container 2 is fitted into the fitting region 3A, the user closes the outer cover 3. In other words, the outer cover 3 is turned from the open position to the closed position.

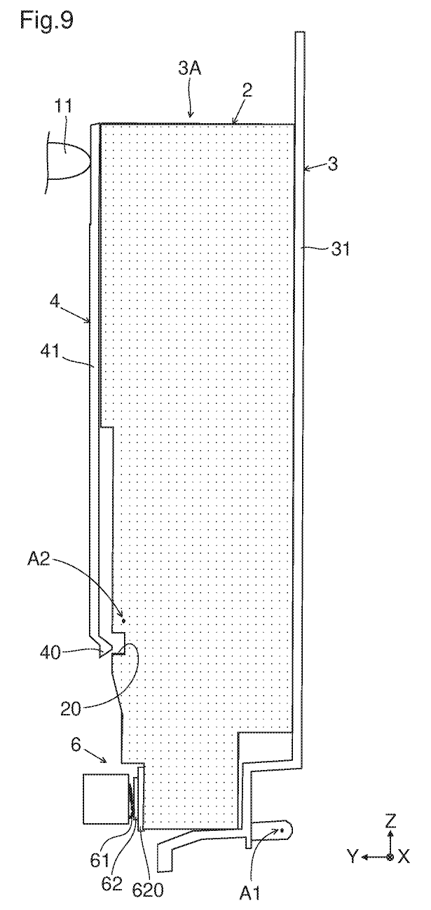

When the outer cover 3 is turned from the open position toward the closed position, and thus the inner cover upper part 41 enters the main body 1, a main body member 11 (see FIG. 9) disposed inside the main body 1 makes contact with the inner cover upper part 41. Thereafter, when the outer cover 3 continues to be turned from the open position toward the closed position, the main body member 11 presses the inner cover upper part 41 from the inner side of the main body 1 to the outer side thereof. Here, the inner cover upper part 41 is turned around the second axis A2, and thus the inner cover upper part 41 is displaced against the biasing force of the torsion coil spring 5 in a direction in which the inner cover upper part 41 approaches the container 2 in the fitting region 3A.

In the state where the outer cover 3 is in the closed position, as shown in FIG. 9, the pressing of the inner cover upper part 41 performed by the main body member 11 is maintained. In this way, the container 2 in the fitting region 3A is sandwiched between the outer cover 3 and the inner cover upper part 41.

When in the state shown in FIG. 9, the outer cover 3 is turned toward the open position, the inner cover upper part 41 is turned around the first axis A1 together with the outer cover 3, and thus the inner cover upper part 41 is displaced in a direction in which the inner cover upper part 41 is moved away from the main body member 11. Finally, the contact between the main body member 11 and the inner cover upper part 41 is released. Furthermore, the inner cover upper part 41 is turned around the second axis A2 by the biasing force of the torsion coil spring 5, and thus the inner cover upper part 41 is displaced in the direction in which the inner cover upper part 41 is moved away from the outer cover 3. This results in a state shown in FIG. 8.

In FIGS. 8 and 9, a dot pattern is provided to the container 2 to clarify the container 2.

Here, as shown in FIGS. 8 and 9, the image forming apparatus 100 includes a container detection unit 6. The container detection unit 6 detects whether the container 2 is fitted into the main body 1. When in the state where the container 2 is fitted into the fitting region 3A, the outer cover 3 is turned from the open position to reach the closed position, the container detection unit 6 detects that the container 2 is fitted into the main body 1. When in the state where the container 2 is fitted into the fitting region 3A, the outer cover 3 is turned from the closed position to the open position, the container detection unit 6 detects that the container 2 is not fitted into the main body 1.

The container detection unit 6 includes a main body-side contact 61. The main body-side contact 61 is disposed inside the main body 1. The main body-side contact 61 is a plate spring, and is made of conductive metal. The main body-side contact 61 is connected to a control unit CON (see FIG. 3). The control unit CON includes a CPU, a memory and the like, and is included in the image forming apparatus 100 to control the image forming apparatus 100.

The container detection unit 6 includes a container-side contact 62. The container-side contact 62 is disposed on the outer surface of the lower end portion of the container 2. For example, a circuit substrate 620 is disposed on the outer surface of the container 2, and the container-side contact 62 is disposed on the circuit substrate 620.

In the state where the outer cover 3 is in the open position (state shown in FIG. 8), the main body-side contact 61 is not in contact with the container-side contact 62. Here, the control unit CON detects that the main body-side contact 61 is not in contact with the container-side contact 62 (that is, is not electrically connected thereto). When the main body-side contact 61 is not in contact with the container-side contact 62, the control unit CON determines that the container 2 is not fitted into the main body 1.

In the state where the outer cover 3 is in the closed position (state shown in FIG. 9), the main body-side contact 61 is in contact with the container-side contact 62. Here, the control unit CON detects that the container-side contact 62 is in contact with the main body-side contact 61 (that is, is electrically connected thereto). When the main body-side contact 61 is in contact with the container-side contact 62, the control unit CON determines that the container 2 is fitted into the main body 1.

When the outer cover 3 is turned from the open position toward the closed position, the main body-side contact 61 makes contact with the container-side contact 62. Here, the control unit CON detects that the main body-side contact 61 makes contact with the container-side contact 62, and determines that the container 2 is fitted into the main body 1. When the outer cover 3 is turned from the closed position toward the open position, the contact between the main body-side contact 61 and the container-side contact 62 is released. Here, the control unit CON detects that the contact between the main body-side contact 61 and the container-side contact 62 is released, and determines that the container 2 is removed from the main body 1.

### Suppression of shifting of container

When the outer cover 3 is turned from the open position toward the closed position, and thus the container-side contact 62 makes contact with the main body-side contact 61, the main body-side contact 61 is elastically deformed. Here, the container-side contact 62 is biased by the biasing force of the main body-side contact 61. In this way, the contact between the main body-side contact 61 and the container-side contact 62 is maintained.

Depending on the shape of the plate spring serving as the main body-side contact 61, after the main body-side contact 61 makes contact with the container-side contact 62, the biasing force in the direction of removal D2 may be applied to the container-side contact 62. In other words, the biasing force in the direction of removal D2 may be applied to the container 2 in the fitting region 3A.

When the outer cover 3 is closed during the fitting/removal operation on the container 2 (that is, when the outer cover 3 is turned from the open position to the closed position), if the container 2 in the fitting region 3A is displaced in the direction of removal D2 by the biasing force of the main body-side contact 61, the displacement suppresses the turning of the outer cover 3 from the open position to the closed position. In this case, the user needs to close the outer cover 3 while holding the container 2, and this may be troublesome depending on the user.

In order to suppress such a disadvantage, the inner cover 4 includes an engagement protrusion 40 (see FIG. 10). The engagement protrusion 40 corresponds to an “engagement portion”. The engagement protrusion 40 protrudes in a hook shape from the lower end portion of the inner cover 4.

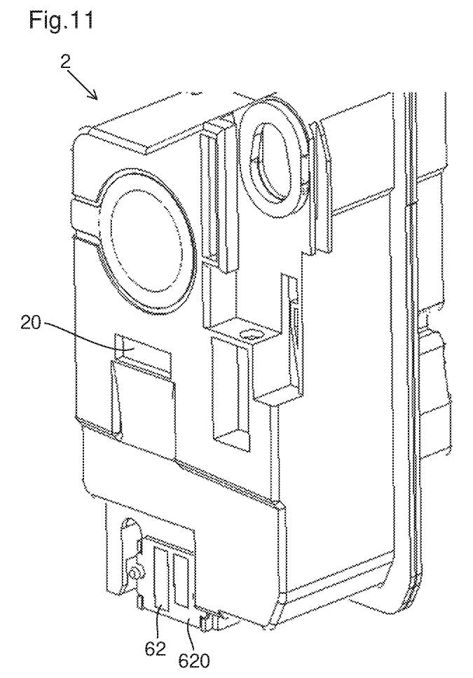

The container 2 includes an engagement recess 20 (see FIG. 11). The engagement recess 20 is disposed on a side opposite the inner cover 4 (on the inner side of the main body 1).

The engagement protrusion 40 can engage with the engagement recess 20. In other words, the engagement protrusion 40 can engage with the container 2 in the fitting region 3A. The engagement protrusion 40 engages with the container 2 in the fitting region 3A to restrict the shifting of the container 2 in the fitting region 3A relative to the outer cover 3.

The engagement protrusion 40 is disposed in a lower part of the inner cover 4 located below the second axis A2 (that is, a lower part located below the inner cover upper part 41). In this way, when the outer cover 3 is turned from the open position toward the closed position, the inner cover upper part 41 is turned around the second axis A2 to approach the container 2 in the fitting region 3A whereas the engagement protrusion 40 is turned around the second axis A2 to move away from the container 2 in the fitting region 3A. When the outer cover 3 is turned from the closed position toward the open position, the inner cover upper part 41 is turned around the second axis A2 to move away from the container 2 in the fitting region 3A whereas the engagement protrusion 40 is turned around the second axis A2 to approach the container 2 in the fitting region 3A.

Here, in a state where the inner cover upper part 41 is not pressed by the main body member 11 from the inner side of the main body 1 toward the outer side thereof (see FIG. 8), the container 2 in the fitting region 3A engages with the engagement protrusion 40. In other words, the engagement recess 20 engages with the engagement protrusion 40. In this way, the displacement of the container 2 in the fitting region 3A in the direction of removal D2 is restricted.

In the present embodiment, when the inner cover upper part 41 is not pressed from the inner side of the main body 1 toward the outer side thereof, the container 2 in the fitting region 3A engages with the engagement protrusion 40, and thus the shifting of the container 2 relative to the outer cover 3 is restricted. In this way, when the user performs an operation of closing the outer cover 3 in which the container 2 is fitted into the fitting region 3A (that is, an operation of fitting the container 2 into the main body 1), it is possible to suppress the floating of the container 2. In other words, when the operation of fitting the container 2 into the main body 1 is performed, the shifting of the container 2 can be suppressed.

In this configuration, when the container 2 is fitted into the main body 1, an operation of holding the container 2 is not needed. In other words, the operation of closing the outer cover 3 is only needed. For example, when the outer cover 3 is closed while the container 2 is being held, this operation needs to be performed with both hands. On the other hand, when the operation of holding the container 2 is not needed, the operation of closing the outer cover 3 is performed with only one hand, with the result that the operation is convenient for the user.

When the container 2 is removed from the fitting region 3A, the inner cover 4 is only moved slightly around the second axis A2. In this way, the engagement of the engagement protrusion 40 and the engagement recess 20 is released. Alternatively, since the biasing force of the torsion coil spring 5 is relatively small, the engagement of the engagement protrusion 40 and the engagement recess 20 is released by a force for moving the container 2 in the direction of removal D2 without the inner cover 4 being intentionally moved.

In the present embodiment, after the outer cover 3 is turned from the open position toward the closed position, and thus the inner cover upper part 41 enters the main body 1, the inner cover upper part 41 is pressed by the main body member 11 from the inner side of the main body 1 to the outer side thereof, and thus the engagement protrusion 40 is turned around the second axis A2 to be displaced in a direction away from the container 2 in the fitting region 3A. Thereafter, when the outer cover 3 continues to be turned from the open position toward the closed position, the engagement of the container 2 in the fitting region 3A and the engagement protrusion 40 is released. In other words, the engagement of the engagement recess 20 and the engagement protrusion 40 is released.

In this way, in the state where the outer cover 3 is in the open position (see FIG. 9), the engagement protrusion 40 does not engage with the container 2 in the fitting region 3A. Consequently, it is possible to suppress the occurrence of a problem in which the engagement of the container 2 in the fitting region 3A and the engagement protrusion 40 inside the main body 1 adversely affects the locating of the container 2 inside the main body 1. In other words, the container 2 can be properly located inside the main body 1.

In the present embodiment, the inner cover 4 is biased by the torsion coil spring 5. In this way, when the inner cover upper part 41 is not pressed by the main body member 11 from the inner side of the main body 1 toward the outer side thereof, the engagement of the container 2 in the fitting region 3A and the engagement protrusion 40 can be reliably maintained by the biasing force of the torsion coil spring 5.

In the present embodiment, the plate spring is used as the main body-side contact 61. In this way, when the outer cover 3 is in the closed position, the contact between the main body-side contact 61 and the container-side contact 62 can be reliably maintained. In the present embodiment, even when the plate spring is used as the main body-side contact 61, it is possible to suppress the shifting of the container 2 when the container 2 is fitted.

The embodiment disclosed herein should be considered to be illustrative in all respects and not restrictive. The scope of the present disclosure is indicated not by the description of the embodiment but by the scope of claims, and furthermore, meanings equivalent to the scope of claims and all changes in the scope are included therein.

What is claimed is:

1. An image forming apparatus comprising:
a main body that includes a printing unit;
a container that stores a toner used in printing performed in the printing unit;
an outer cover that
is supported turnably around a first axis orthogonal to an up/down direction with respect to the main body,
includes a fitting region into which the container is removably fitted and
is displaceable between
an open position where the outer cover is turned around the first axis to expose the fitting region to an outside of the main body, and the container is removable from the fitting region and
a closed position where the container in the fitting region is placed inside the main body; and
an inner cover that is supported turnably around a second axis parallel to the first axis with respect to the outer cover, and sandwiches the container in the fitting region between the outer cover and the inner cover,
wherein the inner cover sandwiches, inside the main body, the container in the fitting region, between the outer cover and an upper part located above the second axis,
after the outer cover is turned from the open position toward the closed position such that the upper part of the inner cover enters the main body, by pressing the upper part of the inner cover from an inner side of the main body toward an outer side thereof, the upper part of the inner cover is turned around the second axis to be displaced in a direction in which the upper part approaches the container in the fitting region,
the inner cover includes an engagement portion in a lower part located below the second axis and
in a state where the upper part of the inner cover is not pressed from the inner side of the main body toward the outer side thereof, the container in the fitting region engages with the engagement portion.

2. The image forming apparatus according to claim 1,
wherein after the outer cover is turned from the open position toward the closed position such that the upper part of the inner cover enters the main body, by pressing the upper part of the inner cover from the inner side of the main body toward the outer side thereof, the engagement portion is turned around the second axis to be displaced in a direction away from the container in the fitting region such that the engagement of the container in the fitting region and the engagement portion is released.

3. The image forming apparatus according to claim 1, further comprising:
a biasing member,
wherein the inner cover is biased by a biasing force of the biasing member in a direction in which the upper part is moved away from the outer cover.

4. The image forming apparatus according to claim 1, further comprising:
a container detection unit that detects whether the container is fitted into the main body,
wherein the container detection unit includes:
a main body-side contact that is disposed in the main body, and includes a plate spring; and
a container-side contact that is disposed in the container, and is electrically connected to the main body-side contact, and
the container-side contact is located away from the main body-side contact in a state where the outer cover is in the open position whereas the container-side contact is in contact with the main body-side contact in a state where the outer cover is in the closed position.
